(19) United States
(12) Patent Application Publication
(10) Pub. No.: US 2019/0043684 A1
(43) Pub. Date: Feb. 7, 2019

(54) VEHICLE-MOUNTED EQUIPMENT OPERATING DEVICE

(71) Applicant: Yazaki Corporation, Tokyo (JP)

(72) Inventors: Yoshiyuki MIZUNO, Makinohara-shi (JP); Takafumi SAITO, Makinohara-shi (JP)

(73) Assignee: Yazaki Corporation, Tokyo (JP)

(21) Appl. No.: 16/025,166

(22) Filed: Jul. 2, 2018

(30) Foreign Application Priority Data
Aug. 4, 2017 (JP) 2017-151573

(51) Int. Cl. H01H 89/00; H01H 3/04; H01H 3/08; H01H 3/12

(52) U.S. Cl. CPC H01H 89/00; H01H 3/04; B60Q 1/0082; H01H 3/12; H01H 3/08

(57) ABSTRACT

Provided are a rotary operating element which is rotated about an axis of a rotation shaft with an operator's finger when operating or stopping vehicle-mounted equipment mounted on a vehicle, a rotary encoder which detects displacement of rotation of the rotary operating element about the axis; and a housing which accommodates the rotary operating element and the rotary encoder and holds the rotary operating element so as to be relatively rotatable about the axis. The rotary operating element has an accommodating chamber in which the rotary encoder is accommodated.

### CROSS-REFERENCE TO RELATED APPLICATION(S)

The present application claims priority to and incorporates by reference the entire contents of Japanese Patent Application No. 2017-151573 filed in Japan on Aug. 4, 2017.

### BACKGROUND OF THE INVENTION

### 1. Field of the Invention

The present invention relates to a vehicle-mounted equipment operating device.

### 2. Description of the Related Art

Conventionally, various types of equipment (hereinafter referred to as “vehicle-mounted equipment”) are mounted on a vehicle, and operating devices (hereinafter referred to as “vehicle-mounted equipment operating device”) used when an operator operates the vehicle-mounted equipment are provided. For example, the following Japanese Patent Application Laid-open No. 2016-168958 discloses a vehicle-mounted equipment operating device installed in a steering wheel. In the vehicle-mounted equipment operating device disclosed in Japanese Patent Application Laid-open No. 2016-168958, a dial operating member as a rotary operating element is arranged at a distal end of a lever, and displacement of rotation of the dial operating member accompanying a rotation operation performed by a driver's finger is detected.

Meanwhile, a rotary encoder is known as a device configured to detect the displacement of rotation of the rotary operating element. For example, the rotary encoder is arranged side by side with the rotary operating element to be coaxial with a rotation shaft of the rotary operating element. Therefore, the conventional vehicle-mounted equipment operating device requires an installation space for each of the rotary operating element and the rotary encoder, and there is room for improvement in terms of suppressing an increase in size of the device.

### SUMMARY OF THE INVENTION

Thus, a purpose of the present invention is to provide a vehicle-mounted equipment operating device capable of suppressing an increase in size.

According to an aspect of the present invention, a vehicle-mounted equipment operating device includes a rotary operating element that is rotated about an axis of the rotation shaft with an operator's finger when operating or stopping a vehicle-mounted equipment mounted on a vehicle, a rotary encoder that detects displacement of rotation of the rotary operating element about the axis, and a housing that accommodates the rotary operating element and the rotary encoder and holds the rotary operating element so as to be relatively rotatable about the axis. The rotary operating element has an accommodating chamber in which the rotary encoder is accommodated.

According to another aspect of the present invention, in the vehicle-mounted equipment operating device, the housing may hold the rotary operating element so as to relatively reciprocate together with the rotary encoder in a direction orthogonal to the rotation shaft. The vehicle-mounted equipment operating device may include a push operation detection unit that detects relative movement of the rotary operating element, which is pushed in one direction during the reciprocation by the finger of the operator, with respect to the housing, and an elastic member that returns the rotary operating element pushed by the operator to an original position.

According to still another aspect of the present invention, the vehicle-mounted equipment operating device may include a longitudinal member that protrudes and extends from at least one of a left end and a right end of a steering column in a vehicle width direction. The housing is provided at a distal end of the longitudinal member in a protruding direction.

According to still another aspect of the present invention, in the vehicle-mounted equipment operating device, the longitudinal member may be an operation lever capable of performing tilting motion with an end on a side of the steering column as a fulcrum, and the vehicle-mounted equipment operating device includes a lever operation detection unit that detects a tilting direction of the tilting motion of the longitudinal member.

According to still another aspect of the present invention, in the vehicle-mounted equipment operating device, the rotary operating element may be arranged at a position that is closer to a vehicle front side than a steering wheel and enables the operator to perform an operation thereof without taking off a hand from the steering wheel.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a front view illustrating a vehicle-mounted equipment operating device according to an embodiment together with a vehicle-mounted equipment operation support system;

FIG. 2 is a top view illustrating the vehicle-mounted equipment operating device according to the embodiment together with the vehicle-mounted equipment operation support system;

FIG. 3 is a perspective view illustrating the vehicle-mounted equipment operating device according to the embodiment;

FIG. 4 is a plan view of an operation unit at a distal end;

FIG. 5 is a cross-sectional view taken along a line X-X of FIG. 4;

FIG. 6 is an exploded perspective view of the operation unit at the distal end; and

FIG. 7 is a front view illustrating a vehicle-mounted equipment operating device according to a modification together with a vehicle-mounted equipment operation support system.

### DETAILED DESCRIPTION OF THE PREFERRED EMBODIMENTS

Hereinafter, an embodiment of a vehicle-mounted equipment operating device according to the present invention will be described in detail with reference to the drawings. Herein, a description will be given together with a vehicle-mounted equipment operation support system provided with the vehicle-mounted equipment operating device. Incidentally, the invention is not limited by the embodiments.

### Embodiment

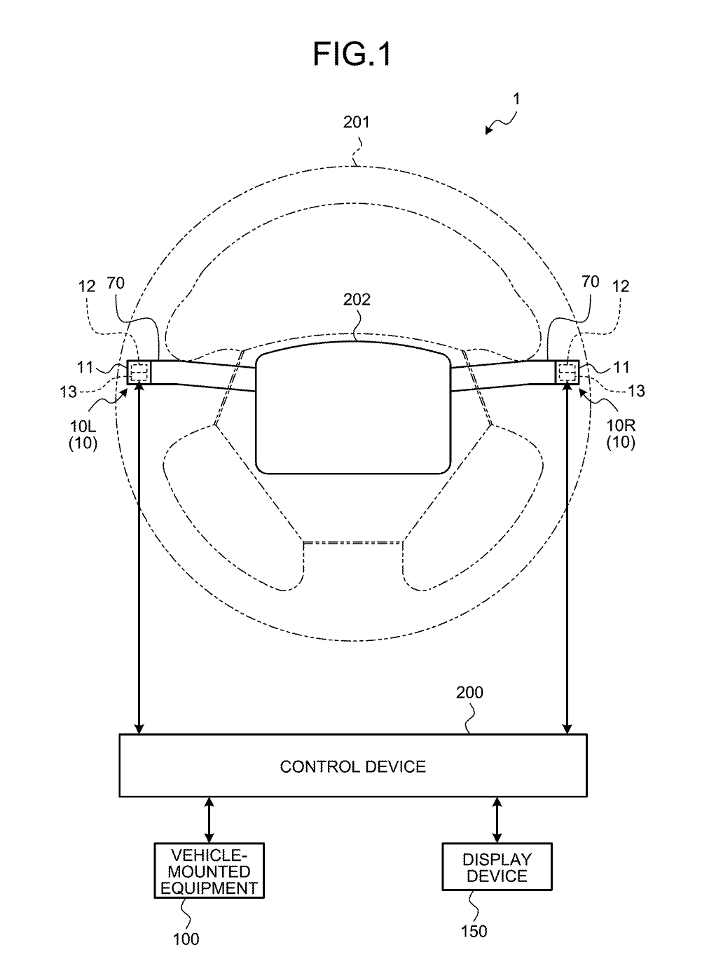

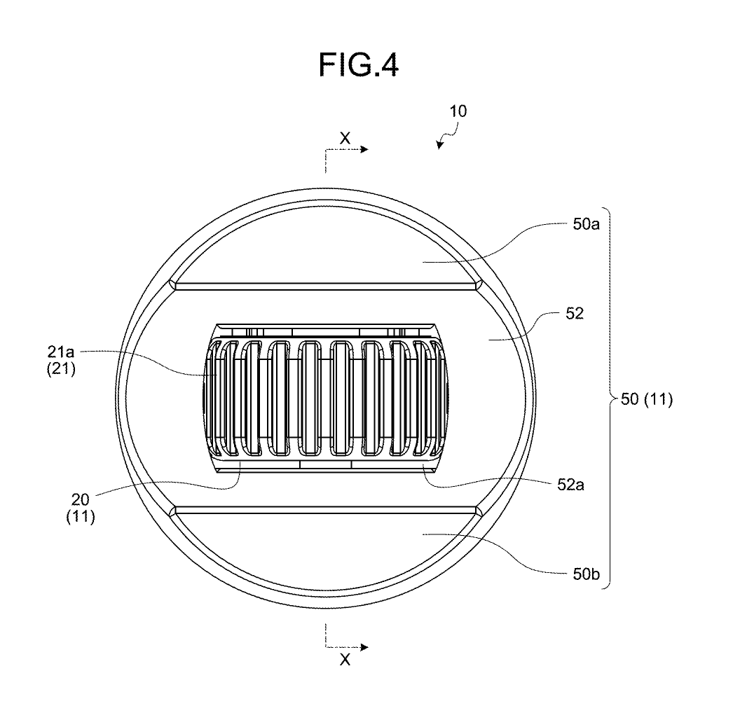

One of embodiments of the vehicle-mounted equipment operating device according to the present invention will be described with reference to FIGS. 1 to 7.

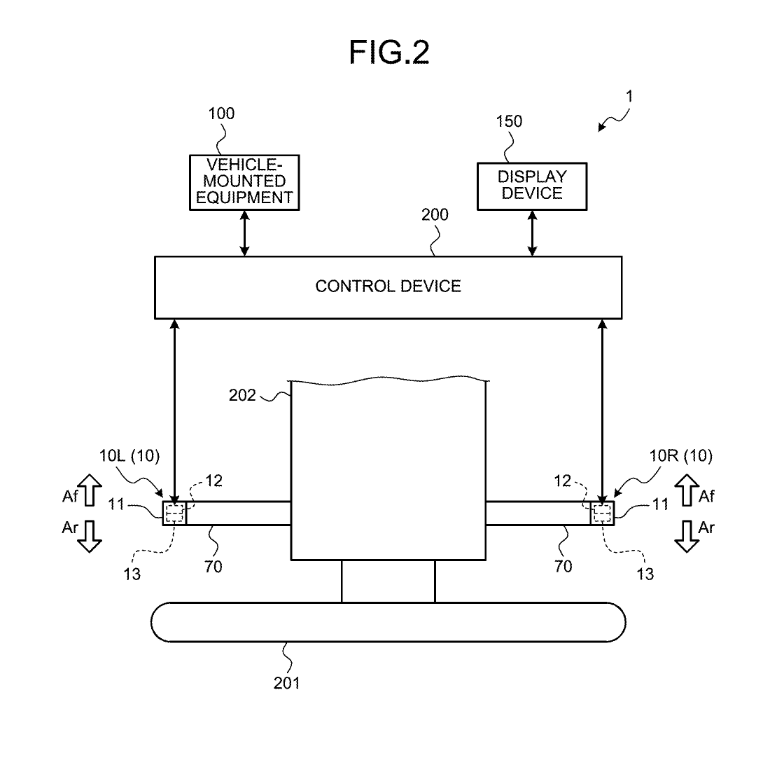

Reference sign 1 in FIGS. 1 and 2 represents the vehicle-mounted equipment operation support system according to the present embodiment. A vehicle-mounted equipment operation support system 1 receives an operation of an operator (such as a driver of a vehicle) and operates or stops equipment (vehicle-mounted equipment) 100 mounted on the vehicle. In addition, when the operator performs the operation with respect to the vehicle-mounted equipment 100, the vehicle-mounted equipment operation support system 1 also supports the operator operating the vehicle-mounted equipment 100 by presenting information (operation-related information) relating to the operation in at least a visible manner.

The vehicle-mounted equipment operation support system 1 according to the present embodiment is provided with: an operation device (vehicle-mounted equipment operating device) 10 configured to operate the vehicle-mounted equipment 100; a display device 150 capable of displaying the operation-related information; and a control device 200 capable of performing control of the vehicle-mounted equipment 100 and display control of the operation-related information onto the display device 150.

The vehicle-mounted equipment operating device 10 allows the operator to perform an operation with a finger when operating or stopping the vehicle-mounted equipment 100. The vehicle-mounted equipment operating device 10 is provided with: at least one operation unit 11 operated by the operator's finger, an operation mode detection unit 12 which detects an operation mode of the operator with respect to the operation unit 11; and a circuit board 13 to which an electric signal of the operation mode detection unit 12 is input and which transmits a detection signal of the operation mode based on the electric signal to the control device 200. The operation unit 11 may be a dedicated operating member for allowing the operator to operate, or may be assigned to a part of a member having a function different from the operation of the operator. The operation mode detection unit 12 is a detector (an encoder, a sensor, or the like), a switch, or the like that detects the operation mode of the operator with respect to the operation unit 11. The control device 200 executes control of the operation and stop of the vehicle-mounted equipment 100 based on the detection signal sent from the circuit board 13. The control device 200 may control the vehicle-mounted equipment 100 itself or control the vehicle-mounted equipment 100 by transmitting operation command information in response to the detection signal to another control device (not illustrated) provided in the vehicle-mounted equipment 100. In addition, the control device 200 displays the operation-related information on the display device 150 based on the detection signal.

In the vehicle-mounted equipment operating device 10, the operation unit 11 is arranged at a position where the operator can operate the operation unit 11 inside a vehicle compartment. In this illustrated example, the operation unit 11 is arranged at a position that is closer to a vehicle front side than a steering wheel 201 (that is, a back side of a steering wheel 201) and enables the operator to perform the operation thereof without taking off a hand from the steering wheel 201. The position is a place where the operator can reach with a fingertip of the finger (for example, a middle finger or an index finger) while holding the steering wheel 201. This position may be any place as long as the position is in the vicinity of a rim of the steering wheel 201, but it is desirable to provide this position in the vicinity of a position at which the steering wheel 201 is held by a general operator. For example, the operation unit 11 of the vehicle-mounted equipment operating device 10 is arranged on at least one of a left side (vehicle left side) and a right side (vehicle right side) in a vehicle width direction when viewed from a center portion of the steering wheel 201. In the illustrated examples of FIGS. 1 and 2, the same vehicle-mounted equipment operating devices 10 are provided on the vehicle left side and the vehicle right side, one by one (vehicle-mounted equipment operating devices 10L and 10R). The operation unit 11 is arranged at a position spaced apart from a left end portion of the steering wheel 201 in the vehicle width direction within a range where a fingertip of a left hand reaches a vehicle front side in the case of the vehicle-mounted equipment operating device 10L on the vehicle left side. In the same manner, the operation unit 11 is arranged at a position spaced apart from a right end portion of the steering wheel 201 in the vehicle width direction within a range where a fingertip of a right hand reaches a vehicle front side in the case of the vehicle-mounted equipment operating device 10R on the vehicle right side. Each of the vehicle-mounted equipment operating devices 10L and 10R is configured to be symmetric right and left as viewed from the center portion of the steering wheel 201. Thus, the vehicle-mounted equipment operating device 10 will be described hereinafter by exemplifying the vehicle-mounted equipment operating device 10R on the vehicle right side as a representative as necessary.

Here, the vehicle-mounted equipment 100 refers to equipment that is mounted at any place in the vehicle regardless of inside or outside of a vehicle compartment, and has at least one function of operating according to the operation of the operator on the operation unit 11 of the vehicle-mounted equipment operating device 10. The vehicle-mounted equipment 100 operates or stops the function (including a change of an operation state) in accordance with an operation command accompanying the operation of the operator. For example, the vehicle-mounted equipment 100 inside the vehicle compartment includes acoustic equipment such as audios and radios, an air conditioning machine (so-called air conditioner), a car navigation system, and the like. In addition, the vehicle-mounted equipment 100 inside the vehicle compartment also includes equipment that is not attached to the vehicle in advance but is mounted on the vehicle as being carried inside the vehicle compartment (for example, communication equipment such as a mobile phone, a portable music player, and the like). On the other hand, the vehicle-mounted equipment 100 outside the vehicle compartment includes vehicle lighting equipment (a headlamp, a taillight, and the like), a direction indicator, a wiper, and the like. The control device 200 may be one that can control the operation and stop of the vehicle-mounted equipment 100.

The operation-related information is information that relates to the operation of the operator on the operation unit 11 of the vehicle-mounted equipment operating device 10. It is possible to consider information that serves as assistance when the operator operates the operation unit 11 of the vehicle-mounted equipment operating device 10 (hereinafter, referred to as “operation assistance information”), information indicating an operation result in a case where the operator operates the operation unit 11 of the vehicle-mounted equipment operating device 10 (hereinafter, referred to as “operation result information”), and information indicating a state of the vehicle-mounted equipment 100 (hereinafter, referred to as “equipment information”), and the like, as the operation-related information. For example, the control device 200 causes at least one of the operation assistance information, the operation result information, and the equipment information to be displayed on the display device 150 as the operation-related information.

For example, a plurality of pieces of selection candidate information selectable by the operator through an operation on the operation unit 11 corresponds to the operation assistance information. In this case, the plurality of pieces of selection candidate information and information indicating the operation mode with respect to the operation unit 11 at the time of selecting desired information from among the plurality of pieces of selection candidate information are displayed on the display device 150 as the operation assistance information.

Specifically, the selection candidate information is information to select an object to be operated from among a plurality of the vehicle-mounted equipment 100 and vehicle-mounted equipment groups (obtained by collectively classifying the same type of vehicle-mounted equipment 100). For example, the selection candidate information is selection icons individually representing the plurality of vehicle-mounted equipment 100 and the vehicle-mounted equipment groups. In addition, the selection candidate information is information to select a desired function from among a plurality of functions of the vehicle-mounted equipment 100, and information to select a desired condition from among a plurality of selection conditions assigned to the functions of the vehicle-mounted equipment 100. For example, when the vehicle-mounted equipment 100 is audio equipment, a selection icon for each function configured to select a desired function from among functions of music selection and volume adjustment, numerical information for each level of volume serving as a selection condition in the volume adjustment function, and the like are used as the selection candidate information.

Current selection candidate information which is a currently selected candidate among the plurality of pieces of selection candidate information, selection confirmation information which has been confirmed the current selection candidate information as a selection target, and the like correspond to the operation result information. In this case, the current selection candidate information and the selection confirmation information are displayed on the display device 150 as the operation result information. For example, the current selection candidate information and the selection confirmation information are displayed using icons or character information.

The equipment information may include not only information on an operation state or a stop state of the vehicle-mounted equipment 100 in a case where the operation unit 11 of the vehicle-mounted equipment operating device 10 is operated but also information on an operation state or a stop state of the vehicle-mounted equipment 100 when the operation unit 11 is not operated. For example, in a case where the vehicle-mounted equipment 100 is the audio equipment, information representing the volume after the volume adjustment is conceivable as the equipment information.

The display device 150 which displays the above-described operation-related information may be a vehicle instrument itself or may be a device that is provided in a partial region of a vehicle instrument. In addition, the display device 150 may be a so-called head-up display device itself or may be a monitor of a car navigation system or the like.

Incidentally, the operation-related information may be not only information that stimulates a visual sense of the operator as above but also information that stimulates an auditory sense of the operator such as a sound and voice.

A specific example of the vehicle-mounted equipment operating device 10 will be described hereinafter.

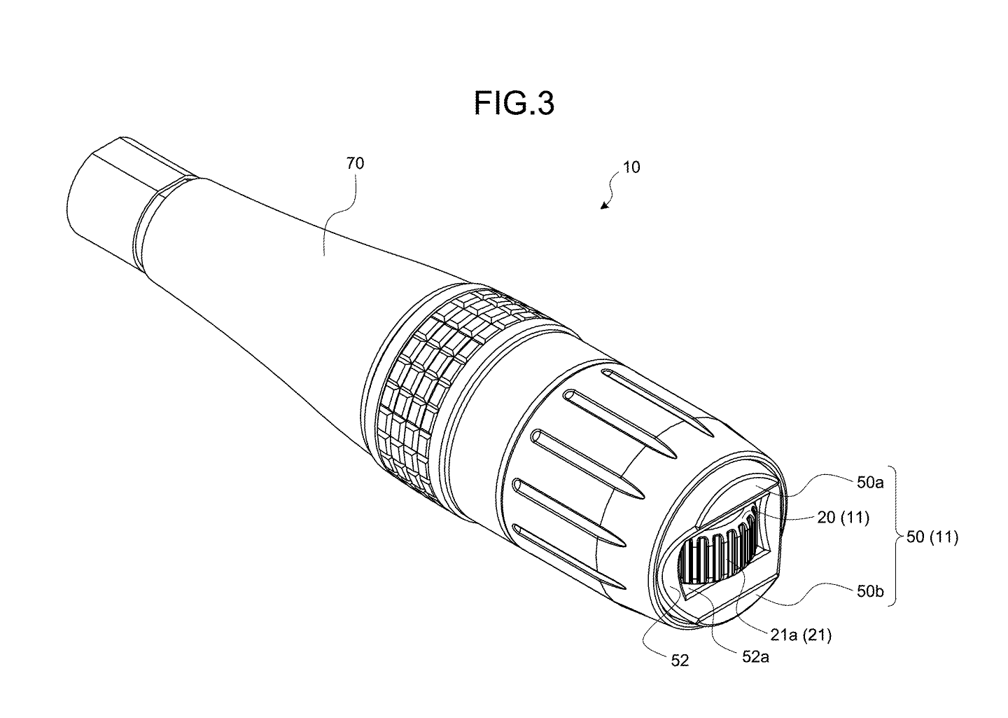

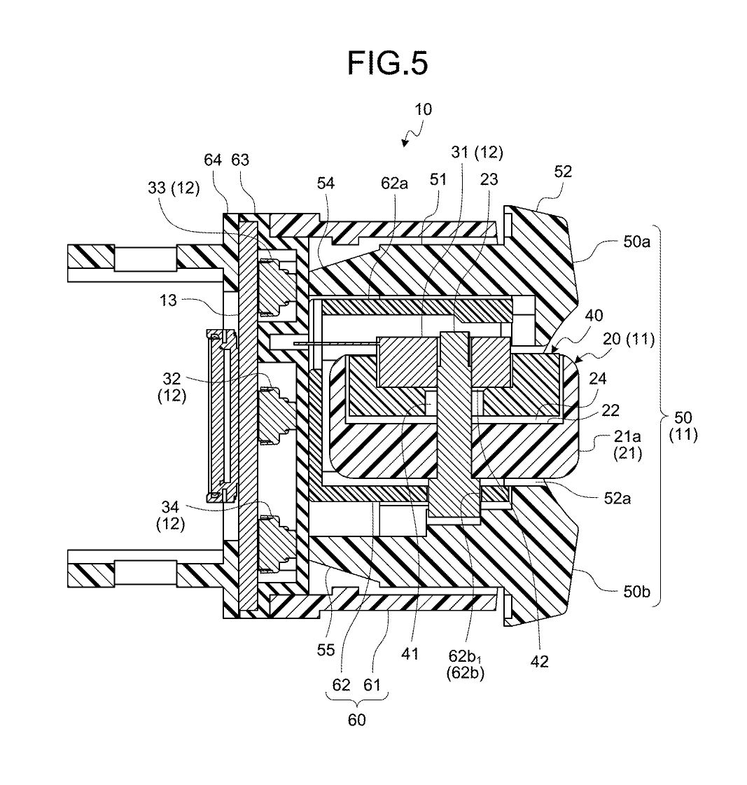

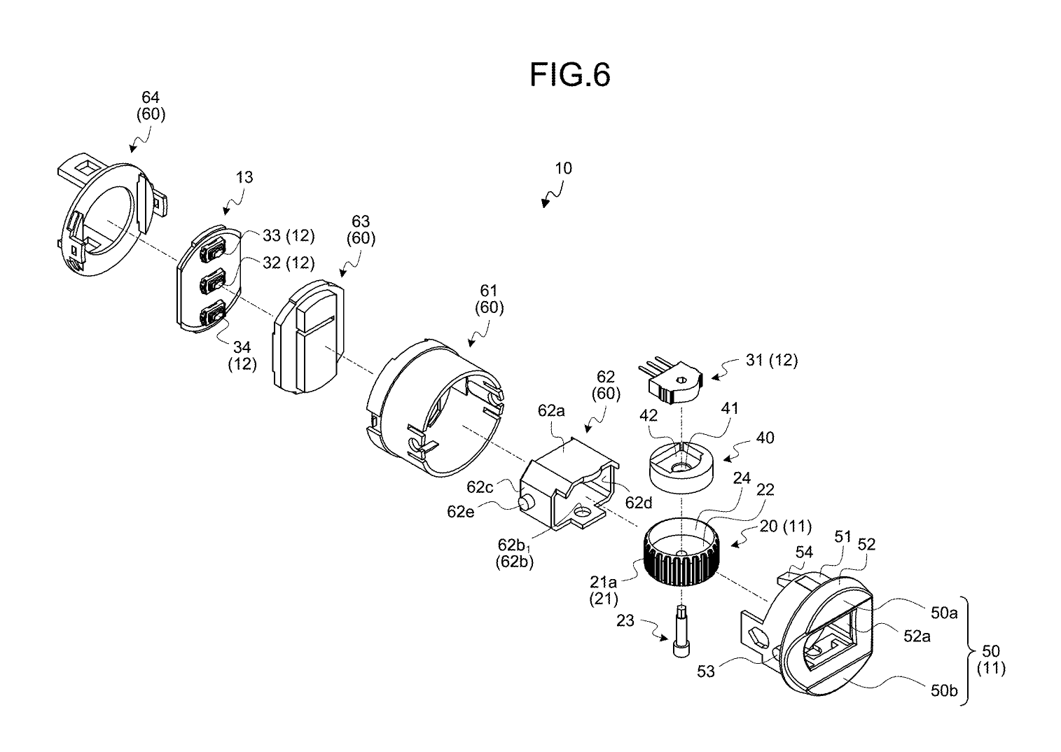

The vehicle-mounted equipment operating device 10 of the present embodiment is provided with at least a rotary operating element 20 that can be rotated about an axis of a rotation shaft as the operation unit 11 (FIGS. 3 to 6). When the vehicle-mounted equipment 100 is operated or stopped, the rotary operating element 20 is rotated about an axis of a rotation shaft with the operator's finger. The rotary operating element 20 is arranged at a position that is closer to the vehicle front side than the steering wheel 201 and enables the operator to perform the operation thereof without taking off the hand from the steering wheel 201. The rotary operating element 20 illustrated in this example is arranged so as to be capable of performing a rotation operation in moving the finger toward the front of the vehicle (an arrow Af in FIG. 2) and a rotation operation in moving the finger toward the rear of the vehicle (an arrow Ar in FIG. 2). In addition, the vehicle-mounted equipment operating device 10 is provided with at least a rotary encoder 31 which detects the displacement of rotation of the rotary operating element 20 about the axis as the operation mode detection unit 12 (FIGS. 5 and 6).

The rotary operating element 20 illustrated in this example is a dial operating member that is rotatable about an axis of one rotation shaft and has a cylindrical portion 21 concentric with the rotation shaft thereof (FIGS. 3 to 6). An outer peripheral wall 21a of the cylindrical portion 21 serves as an operating point (rotational operating point) as a point to be rotated by a finger. The outer peripheral wall 21a is formed in a concavo-convex shape in which a plurality of concave portions and convex portions are arranged at equal intervals in a peripheral direction in order to suppress slippage of the finger during the rotating operation. The rotary operating element 20 is molded using an insulating material such as synthetic resin.

In the rotary operating element 20, one circular opening in the cylindrical portion 21 is closed by a disk-shaped or columnar closing portion 22 (FIGS. 5 and 6). In the rotary operating element 20, a columnar or cylindrical pin member 23 is fitted and fixed to a through-hole of an axial center of the closing portion 22. In the rotary operating element 20, the pin member 23 serves as a rotation shaft.

The rotary operating element 20 has an accommodating chamber 24 in which the rotary encoder 31 is accommodated (FIGS. 5 and 6). For example, a columnar internal space (actually, an annular internal space due to the presence of the pin member 23) surrounded by the cylindrical portion 21 and the closing portion 22 is formed in the rotary operating element 20. The rotary operating element 20 uses this internal space as the accommodating chamber 24. It is desirable that the accommodating chamber 24 have such a size that the rotary encoder 31 can be completely accommodated in the chamber. In addition, it is desirable to form the accommodating chamber 24 to have such a size that the sticking-out amount of the rotary encoder 31 is minimized even if the rotary encoder 31 sticks out from the inside of the chamber.

Here, although not illustrated, the rotary encoder 31 detects rotational displacement of a rotator (not illustrated), which rotates integrally with the rotary operating element 20 and the pin member 23, with a detector (not illustrated). The rotator and the detector are accommodated in a housing. The rotator relatively rotates about the axis with respect to the detector and the housing, thereby causing the detector to detect its rotational displacement. The rotary encoder 31 is electrically connected to the circuit board 13, and transmits an electric signal corresponding to the rotational displacement of the rotational displacement of the rotator to the circuit board 13.

The rotary encoder 31 is accommodated in the accommodating chamber 24 in a state where the rotator is engaged with the pin member 23, and rotates the rotator in conjunction with the rotation of the rotary operating element 20 about the axis. The rotary encoder 31 illustrated in this example is held by a holding member 40 and accommodated in the accommodating chamber 24 together with the holding member 40 (FIGS. 5 and 6). The holding member 40 holds a housing of the rotary encoder 31 in the accommodating chamber 24 and is held in the rotary operating element 20 so as to be relatively rotatable about the axis between the housing of the rotary encoder 31 and the rotary operating element 20. Accordingly, when the rotary operating element 20 rotates about the axis, the detector of the rotary encoder 31 and the housing remain stationary while the rotator of the rotary encoder 31 rotates in conjunction with the rotation of the rotary operating element 20 in the vehicle-mounted equipment operating device 10. Therefore, the vehicle-mounted equipment operating device 10 can detect the rotation of the rotary operating element 20 using the rotary encoder 31.

The holding member 40 illustrated in this example is molded using an insulating material such as synthetic resin in a cylindrical shape having an outer diameter smaller than an inner diameter of the accommodating chamber 24 of the rotary operating element 20. The holding member 40 has a through-hole 41 through which the pin member 23 is inserted (FIGS. 5 and 6). The holding member 40 is relatively rotated about the axis with respect to the pin member 23, for example, via a bearing (not illustrated). Accordingly, the rotary operating element 20 can hold the holding member 40 and can relatively rotate about the axis with respect to the holding member 40. In addition, the holding member 40 has an accommodating chamber 42 in which the rotary encoder 31 is accommodated (FIGS. 5 and 6). The accommodating chamber 42 is formed so as to conform to a shape of the housing of the rotary encoder 31 and, for example, is fitted to fix this housing.

In the vehicle-mounted equipment operating device 10 illustrated in this example, the rotary operating element 20 is also used as a push operating element that is pushed by the operator's finger. Accordingly, the vehicle-mounted equipment operating device 10 is also provided with a push operation detection unit 32 which detects the movement of the pushed rotary operating element 20 as the operation mode detection unit 12 (FIGS. 5 and 6). A switch operating in response to the movement of the rotary operating element 20 is used for the push operation detection unit 32. Here, for example, a tact switch or a metal dome switch is used as the push operation detection unit 32. The push operation detection unit 32 is electrically connected to the circuit board 13, and transmits an electric signal (on signal) when actuated in accordance with the push operation to the circuit board 13. In the vehicle-mounted equipment operating device 10 illustrated in this example, as the rotary operating element 20 is pushed, the rotary encoder 31 and the holding member 40 also relatively move integrally with the rotary operating element 20. Such movement will be described in detail later.

Further, the vehicle-mounted equipment operating device 10 illustrated in this example is provided with a push operating element 50 that is pushed by the operator's finger, as the operation unit 11, in addition to the rotary operating element 20 (FIGS. 3 to 6). The push operating element 50 is arranged at a position that is closer to the vehicle front side than the steering wheel 201 and enables the operator to perform the operation thereof without taking off the hand from the steering wheel 201. The push operating element 50 has first and second push operating points 50a and 50b as points to be pushed. Accordingly, the vehicle-mounted equipment operating device 10 is provided with a push operation detection unit 33 corresponding to the first push operating point 50a and a push operation detection unit 34 corresponding to the second push operating point 50b as the operation mode detection unit 12 (FIGS. 5 and 6). The push operation detection unit 33 detects the movement of the push operating element 50 when the first push operating point 50a is pushed. The push operation detection unit 34 detects the movement of the push operating element 50 when the second push operating point 50b is pushed. A tact switch or a metal dome switch is used for these push operation detection units 33 and 34 in the same manner as the push operation detection unit 32 described above. Therefore, each of the push operation detection units 33 and 34 is electrically connected to the circuit board 13, and the electric signal (switch-on signal) when actuated in accordance with the push operation is transmitted to the circuit board 13.

The vehicle-mounted equipment operating device 10 is provided with a housing 60 that accommodates the rotary operating element 20, the push operating element 50, the rotary encoder 31, the push operation detection units 32, 33, and 34, and the holding member 40 (FIGS. 5 and 6).

The housing 60 includes a cylindrical main body 61 and a holding member 62 accommodated in a space inside the main body 61. The housing 60 is molded using an insulating material such as synthetic resin.

The main body 61 exposes a part of the outer peripheral wall 21a of the rotary operating element 20 from one opening. The rotary operating element 20 is rotated at its exposed part.

The holding member 62 is a member that accommodates and holds the rotary operating element 20, the rotary encoder 31, and the holding member 40. The holding member 62 rotatably holds the rotary operating element 20 via the pin member 23 such that the rotary operating element 20 can relatively rotate about the axis. The holding member 62 illustrated in this example is molded in a rectangular tube shape and is accommodated in the space inside the main body 61 in a state where cylindrical axis directions of the holding member 62 and the main body 61 are aligned. The pin member 23 is inserted into one through-hole of the holding member 62 (a through-hole 62b₁ of a wall body 62b) between two wall bodies 62a and 62b opposing each other in a direction orthogonal to the cylinder axis direction so as to have an axis aligned in the orthogonal direction (FIGS. 5 and 6). The pin member 23 is arranged in a space inside the holding member 62. At this position, the pin member 23 is attached so as to be relatively rotatable about the axis with respect to the holding member 62, for example, via a bearing (not illustrated). That is, the rotary operating element 20 is held by the holding member 62 via the pin member 23, and can relatively rotate about the axis of the pin member 23 with respect to the holding member 62. Accordingly, the housing 60 can hold the rotary operating element 20 so as to be capable of causing the rotary operating element 20 to relatively rotate about the axis.

Here, the holding member 62 is housed so as to be capable of relatively reciprocating in the cylinder axial direction with respect to the main body 61. The housing accordingly 60 can hold the rotary operating element 20 so as to be capable of causing the rotary operating element 20 to relatively reciprocate in the cylinder axis direction of the main body 61 and the holding member 62. That is, the housing 60 can hold the rotary operating element 20 so as to be capable of causing the rotary operating element 20 to relatively reciprocate together with the rotary encoder 31 in the direction orthogonal to the pin member 23 which is the rotation shaft. Therefore, the rotary operating element 20 can be used as the push operating element pushed by the operator's finger in the vehicle-mounted equipment operating device 10 as described above. In the vehicle-mounted equipment operating device 10 illustrated in this example, the push operation detection unit 32 is actuated via the holding member 62 when the rotary operating element 20 is pushed in one direction during the reciprocation by the operator's finger. Accordingly, the push operation detection unit 32 can detect the relative movement of the pushed rotary operating element 20 with respect to the housing 60 in the vehicle-mounted equipment operating device 10.

The holding member 62 illustrated in this example includes guide portions 62e protruding toward the outside, respectively, in two wall bodies 62c and 62d opposing each other in the direction orthogonal to the cylinder axis direction (here, the direction orthogonal to the axial direction of the attached pin member 23 and its own cylinder axis direction) (FIG. 6). In this drawing, only the guide portion 62e on one side is illustrated for the sake of convenience. Each of the guide portions 62e is formed in a columnar shape with the orthogonal direction thereof as the axial direction and guides the relative reciprocation of the holding member 62 in the cylinder axis direction with respect to the main body 61. The vehicle-mounted equipment operating device 10 has a guide groove (not illustrated) which guides the guide portion 62e along with the reciprocation. The guide groove may be formed in, for example, the main body 61 or the holding member 62, or may be formed between the main body 61 and the holding member 62.

In addition, an elastic member 63 is interposed between the holding member 62 and the push operation detection unit 32 in the vehicle-mounted equipment operating device 10 illustrated in this example (FIGS. 5 and 6). The elastic member 63 is a member configured to return the rotary operating element 20, which has been pushed by the operator, to an original position. When the rotary operating element 20 is pushed, the elastic member 63 is pushed by the holding member 62 to actuate the push operation detection unit 32 while deflecting. On the other hand, when the operator stops the push operation and takes off the finger from the rotary operating element 20, the elastic member 63 switches off the push operation detection unit 32 while eliminating the deflection, and returns the rotary operating element 20 to the original position together with the holding member 62. The elastic member 63 illustrated in this example is formed and arranged so as to close the other opening of the main body 61. In addition, the elastic member 63 illustrated in this example covers the circuit board 13 together with the push operation detection units 32, 33, and 34.

The housing 60 illustrated in this example is provided with a lid member 64 which sandwiches the circuit board 13 covered by the elastic member 63 and the push operation detection units 32, 33, and 34 with the main body 61 and closes the other opening of the main body 61 (FIGS. 5 and 6). The lid body 64 has the main body part formed in an annular shape. In this illustrated example, a through-hole inside the lid body 64 is closed with the circuit board 13 covered by the elastic member 63, and it is possible to say that the circuit board 13 covered by the elastic member 63 also forms a part of the housing 60.

The push operating element 50 has a cylindrical tube body 51 accommodated in a space inside the main body 61 of the housing 60 and a lid body 52 which closes one opening of the tube body 51. The push operating element 50 is molded using an insulating material such as synthetic resin (FIGS. 5 and 6).

The tube body 51 accommodates the holding member 62 in an internal space thereof. The tube body 51 and the holding member 62 are arranged so as to be movable relative to each other in the axial direction.

When the tube body 51 is accommodated in the space inside the main body 61, the lid body 52 closes one opening of the main body 61. Therefore, a rectangular opening portion 52a which exposes a part of the outer peripheral wall 21a of the rotary operating element 20 is formed in the lid body 52 (FIGS. 3 to 6). In the lid body 52, the first push operating point 50a and the second push operating point 50b are arranged to oppose each other so as to sandwich the opening portion 52a.

The push operating element 50 has a rotation shaft 53 whose axis is a direction orthogonal to an opposing arrangement direction of the first push operating point 50a and the second push operating point 50b and the cylinder axis direction of the tube body 51 (FIG. 6). The rotation shaft 53 is attached to the main body 61 such that the relative rotation of the housing 60 about the axis with respect to the main body 61 can be performed. Accordingly, the push operating element 50 can relatively rotate about the axis of the rotation shaft 53 with respect to the housing 60. In this illustrated example, the two columnar rotation shafts 53 coaxially protrude from an outer peripheral wall of the tube body 51. In this drawing, only the rotation shaft 53 on one side is illustrated for the sake of convenience.

For example, when the first push operating point 50a is pushed, the first push operating point 50a is pushed inward while the push operating element 50 relatively rotates with respect to the housing 60. In addition, when the second push operating point 50b is pushed, the second push operating point 50b is pushed inward while the push operating element 50 relatively rotates with respect to the housing 60 in a direction opposite to a direction in the case of the first push operating point 50a. In the vehicle-mounted equipment operating device 10, the push operation detection unit 33 is arranged at a distal point of a portion in which the first push operating point 50a is pushed inward. Therefore, the push operating element 50 has a protruding portion 54 which actuates the push operation detection unit 33 when the first push operating point 50a is pushed inward (FIGS. 5 and 6). In addition, the push operation detection unit 34 is arranged at a distal point of a portion in which the second push operating point 50b is pushed inward in the vehicle-mounted equipment operating device 10. Accordingly, the push operating element 50 has a protruding portion 55 which actuates the push operation detection unit 34 when the second push operating point 50b is pushed inward (FIG. 5). Each of the protruding portions 54 and 55 protrudes from a side of the other opening of the tube body 51.

Here, the elastic member 63 described above is also interposed between the first push operating point 50a and the push operation detection unit 33 and between the second push operating point 50b and the push operation detection unit 34. That is, the elastic member 63 is also used to return the first push operating point 50a and the second push operating point 50b, which have been pushed by the operator, to original positions thereof. When the first push operating point 50a is pushed, the elastic member 63 is pushed by the protruding portion 54 to actuate the push operation detection unit 33 while deflecting. On the other hand, when the operator stops the push operation and takes off the finger from the first push operating point 50a, the elastic member 63 switches off the push operation detection unit 33 while eliminating the deflection, and returns the first push operating point 50a to the original position. In the same manner, the elastic member 63 actuates the push operation detection unit 34 along with the push operation of the second push operating point 50b, and switches off the push operation detection unit 34 and pushes the second push operating point 50b back to the original position along with the stop of the push operation of the second push operating point 50b.

The vehicle-mounted equipment operating device 10 illustrated in this example is provided with a longitudinal member 70 that protrudes and extends from at least one of a left end and a right end of a steering column 202 in the vehicle width direction (FIGS. 1 to 3). Here, the longitudinal member 70 is provided for each of the left and right vehicle-mounted equipment operating devices 10L and 10R. The longitudinal member 70 is a member that connects the operation unit 11 and the steering column 202, and the operation unit 11 is provided at a distal end in a protruding direction of the longitudinal member 70. The longitudinal member 70 may be molded in a straight shape or provided with a bent portion in the middle of a path as long as the longitudinal member 70 extends between the operation unit 11 and the steering column 202. The longitudinal member 70 is formed in, for example, a cylindrical shape, and the housing 60 is fitted and fixed into an internal space at the distal end thereof, thereby arranging the operation unit 11 at the distal end.

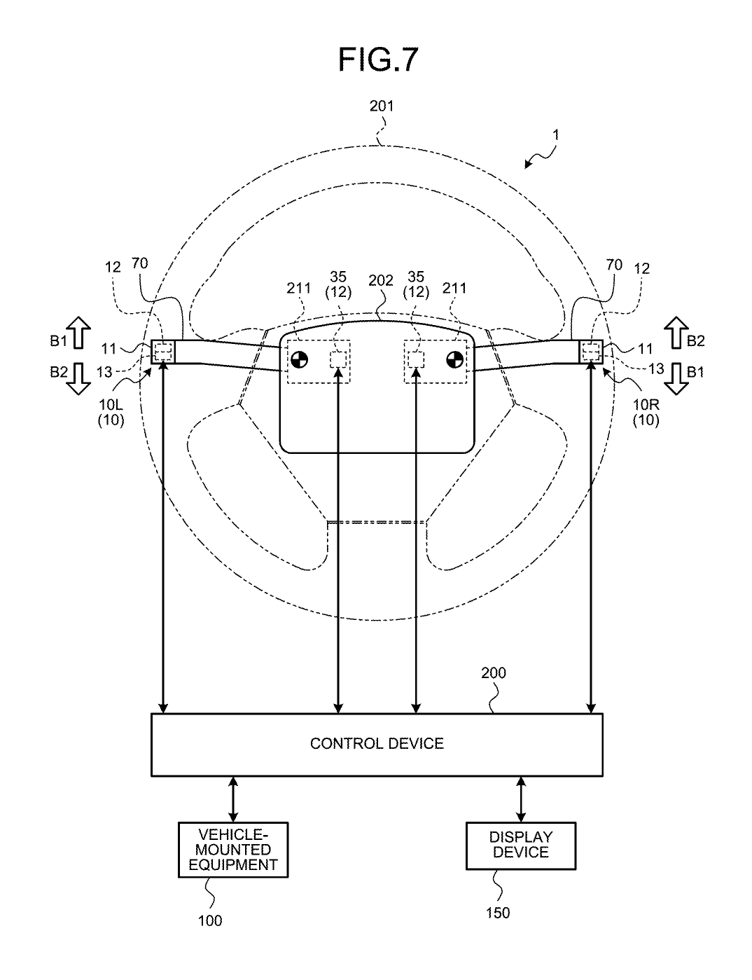

Meanwhile, the longitudinal member 70 may be provided as an operation lever capable of tilting with an end on a side of the steering column 202 as a fulcrum. The operation lever is used to operate the vehicle-mounted equipment 100. For example, a winker lever or the like is known as this operation lever. The longitudinal member 70 is supported by a support portion 211, which is fixed inside the steering column 202, to be freely tilted (FIG. 7). The support portion 211 is configured so as to be freely tilted with an end portion of the longitudinal member 70 on the steering column 202 side as a fulcrum. The longitudinal member 70 illustrated in this example can perform tilting motion toward the front of the vehicle (the arrow Af in FIG. 2), tilting motion toward the rear of the vehicle (the arrow Ar in FIG. 2), clockwise tilting motion toward one peripheral direction (an arrow B1 in FIG. 7), and counterclockwise tilting motion toward the other peripheral direction (an arrow B2 in FIG. 7) with a neutral position as a base point. At least one of the vehicle-mounted equipment 100 and at least one function of the vehicle-mounted equipment 100 are assigned in each operation direction of the longitudinal member 70.

Here, the support portion 211 may be configured such that the longitudinal member 70 returns to the neutral position by a spring force or the like after being tilted to a certain operation direction from the neutral position or may be configured such that the longitudinal member 70 is manually operated to return to the neutral position by the operator after the longitudinal member 70 is tilted from the neutral position to a certain operation direction. In the latter case, the support portion 211 is configured such that at least one step of tilting motion of the longitudinal member 70 can be performed. In the longitudinal member 70 in this case, a distal end part in its protruding direction serves as the operation unit 11 for the tilting motion.

The vehicle-mounted equipment operating device 10 in this case is provided with a lever operation detection unit 35, which detects a tilting direction of the tilting motion of the longitudinal member 70, as the operation mode detection unit 12 (FIG. 7). The lever operation detection unit 35 transmits an output signal according to the tilting direction of the longitudinal member 70 to the control device 200. The control device 200 can detect the operation direction of the longitudinal member 70 performed by the operator based on the output signal. The control device 200 executes control of the vehicle-mounted equipment 100 according to the operation direction.

As described above, the rotary encoder 31 is arranged at the inner side of the rotary operating element 20 in the vehicle-mounted equipment operating device 10 of the present embodiment, and it is unnecessary to provide an installation space for each of the rotary operating element 20 and the rotary encoder 31. Therefore, the vehicle-mounted equipment operating device 10 can suppress the increase in size. In particular, the rotary operating element 20 is arranged in a region having a size only as large as the fingertip of the finger in the vehicle-mounted equipment operating device 10, and thus, it is necessary to increase the size of the rotary operating element 20 as much as possible within the region in order to enable a rotating operation with the operator's fingertip and to transmit operational feeling of the rotating operation to the operator's finger. That is, it is difficult to reduce the size of the rotary operating element 20 in the vehicle-mounted equipment operating device 10. However, the vehicle-mounted equipment operating device 10 of the present embodiment can secure the necessary size of the rotary operating element 20 while suppressing the increase in size by arranging the rotary encoder 31 inside the rotary operating element 20. In addition, since the rotary encoder 31 can be arranged inside the rotary operating element 20 while suppressing an increase in the number of parts and assembly steps, the vehicle-mounted equipment operating device 10 of the present embodiment can suppress the increase in size while suppressing a cost rise.

In a vehicle-mounted equipment operating device according to the present embodiment, a rotary encoder is arranged inside a rotary operating element, and it is unnecessary to provide an installation space for each of the rotary operating element and the rotary encoder. Therefore, this vehicle-mounted equipment operating device can suppress the increase in size.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle-mounted equipment operating device comprising:
a rotary operating element that is rotated about an axis of a rotation shaft with an operator's finger when operating or stopping vehicle-mounted equipment mounted on a vehicle;
a rotary encoder that detects displacement of rotation of the rotary operating element about the axis; and
a housing that accommodates the rotary operating element and the rotary encoder and holds the rotary operating element so as to be relatively rotatable about the axis, wherein
the rotary operating element includes an accommodating chamber in which the rotary encoder is accommodated.

2. The vehicle-mounted equipment operating device according to claim 1, wherein
the housing holds the rotary operating element so as to relatively reciprocate together with the rotary encoder in a direction orthogonal to the rotation shaft, and
the vehicle-mounted equipment operating device further comprises:
a push operation detection unit that detects relative movement of the rotary operating element, which is pushed in one direction during the reciprocation by the finger of the operator, with respect to the housing, and
an elastic member that returns the rotary operating element pushed by the operator to an original position.

3. The vehicle-mounted equipment operating device according to claim 1 further comprising:
a longitudinal member that protrudes and extends from at least one of a left end and a right end of a steering column in a vehicle width direction, wherein
the housing is provided at a distal end of the longitudinal member in a protruding direction.

4. The vehicle-mounted equipment operating device according to claim 2 further comprising:
a longitudinal member that protrudes and extends from at least one of a left end and a right end of a steering column in a vehicle width direction, wherein
the housing is provided at a distal end of the longitudinal member in a protruding direction.

5. The vehicle-mounted equipment operating device according to claim 3, wherein
the longitudinal member is an operation lever capable of performing tilting motion with an end on a side of the steering column as a fulcrum, and
the vehicle-mounted equipment operating device further comprises a lever operation detection unit that detects a tilting direction of the tilting motion of the longitudinal member.

6. The vehicle-mounted equipment operating device according to claim 4, wherein
the longitudinal member is an operation lever capable of performing tilting motion with an end on a side of the steering column as a fulcrum, and
the vehicle-mounted equipment operating device further comprises a lever operation detection unit that detects a tilting direction of the tilting motion of the longitudinal member.

7. The vehicle-mounted equipment operating device according to claim 1, wherein
the rotary operating element is arranged at a position that is closer to a vehicle front side than a steering wheel and enables the operator to perform an operation thereof without taking off a hand from the steering wheel.

8. The vehicle-mounted equipment operating device according to claim 2, wherein
the rotary operating element is arranged at a position that is closer to a vehicle front side than a steering wheel and enables the operator to perform an operation thereof without taking off a hand from the steering wheel.

9. The vehicle-mounted equipment operating device according to claim 3, wherein
the rotary operating element is arranged at a position that is closer to a vehicle front side than a steering wheel and enables the operator to perform an operation thereof without taking off a hand from the steering wheel.

10. The vehicle-mounted equipment operating device according to claim 4, wherein
the rotary operating element is arranged at a position that is closer to a vehicle front side than a steering wheel and enables the operator to perform an operation thereof without taking off a hand from the steering wheel.

11. The vehicle-mounted equipment operating device according to claim 5, wherein
the rotary operating element is arranged at a position that is closer to a vehicle front side than a steering wheel and enables the operator to perform an operation thereof without taking off a hand from the steering wheel.

12. The vehicle-mounted equipment operating device according to claim 6, wherein
the rotary operating element is arranged at a position that is closer to a vehicle front side than a steering wheel and enables the operator to perform an operation thereof without taking off a hand from the steering wheel.
